(19) United States
(12) Patent Application Publication
(10) Pub. No.: US 2007/0230508 A1
(43) Pub. Date: Oct. 4, 2007

(54) METHOD AND SYSTEM FOR SWITCHING BETWEEN VIDEO SOURCES

(76) Inventors: Patrick McCusker, Ellicott City, MD (US); Chris Tengwall, Davidsonville, MD (US); Scott Belden, Arnold, MD (US); Stanton D. Anderson, Washington, DC (US)

Correspondence Address: DLA PIPER US LLP;ATTN: PATENT GROUP, 1200 NINETEENTH STREET, NW, WASHINGTON, DC, 20036, US

(21) Appl. No.: 11/694,349

(22) Filed: Mar. 30, 2007

Related U.S. Application Data
(60) Provisional application No. 60/744,079, filed on Mar. 31, 2006.

(51) Int. Cl. H04H 1/04

(52) U.S. Cl. 370/486

(57) ABSTRACT

A network convergence component switches an output to a viewing device from a first source to a preferred source during periods when an event such as a commercial is detected. In some embodiments, the network convergence component is under local control. In other embodiments, the network convergence component is under the control of a network operations center, which is linked to a plurality of network convergence components. The preferred source may also be connected to the network operations center so that the network operations center may push content to the preferred source.

### CROSS REFERENCE TO RELATED APPLICATIONS

This application is based on, and claims priority to, U.S. Provisional Application Ser. No. 60/744,079, filed Mar. 31, 2006, the entire contents of which are hereby incorporated by reference.

### BACKGROUND

1. Field of the Invention

The present invention relates generally to a system comprising hardware and/or software for switching from one source of data to a second source of data during the detection of an event in one of the sources of data.

2. Discussion of the Background

Traditional TV advertising has long taken a shotgun approach to reaching consumers—hitting as many people as possible—regardless of whether they were potential customers or not. The conventional wisdom was to leverage the mass-market appeal of television to create as many impressions as possible. Today, fragmenting media and changing consumer behavior have made it increasingly difficult and costly for companies and their advertisers to reach new customers.

As companies continue to battle for the most efficient and effective medium to capture their target audience, the information highways are becoming cluttered and a new, more effective means for targeted communications is needed.

### SUMMARY

Rather than the mass-audience approach to TV advertising, the inventive methods and devices disclosed herein fundamentally changes the way companies market and manage their brands by enabling them to reach specific demographics at specific locations at a much lower cost than traditional advertising. In one aspect of the invention, an output to a viewing device is switched from a central source to a preferred source during an event such as a television commercial in the central source.

In one embodiment, an approach to advertising is to link TVs within individual high-traffic locations allowing companies to customize and optimize their TV advertising at the national, regional and local levels. In one embodiment, the advertising may be controlled locally, such as at a particular physical site. Another embodiment includes a national network of closed-circuit TVs that connects popular theme-based locations such as health clubs or sports bars and substitute existing cable and satellite TV advertising with our client's customized and targeted ad content. Still other embodiments are discussed herein.

### BRIEF DESCRIPTION OF THE DRAWINGS

The following detailed description will be better understood with reference to following drawings, in which like reference numerals are used to refer to like elements.

FIG. 1 shows a block diagram of a system according to one embodiment of the invention.

FIG. 2 shows a block diagram of a system according to a second embodiment of the invention.

### DETAILED DESCRIPTION

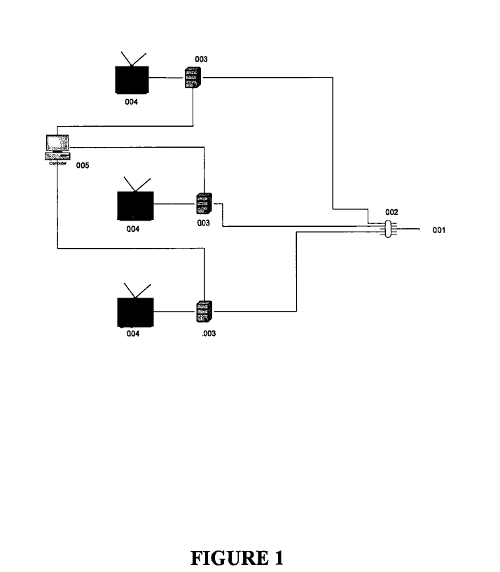

A preferred embodiment of the invention applicable to a television or monitor environment is illustrated in FIG. 1. Audiovisual information from a central source 1 is fed to a splitter 2. The central source may be cable, satellite, terrestrial broadcast, IP based TV and wireless access based TV. The central source 1 should be understood as including any local device needed to receive data, such as television programming, via cable or satellite set top box. The audiovisual signal from the central source 1 is fed to a splitter 2. The splitter 2 feeds the audiovisual signal to a plurality of network convergence components 3. The network convergence components 3 are each connected to a respective television, monitor or viewing device 4. Also connected to the network convergence components 3 are feeds from a preferred video source 5, which is a personal computer in this embodiment but which can be any device that is capable of storing audiovisual information and outputting the stored audiovisual information, preferably but not necessarily on command.

The network convergence component 3 functions to monitor the audiovisual signal from the central source 1 and switch between the audiovisual information from the central source 1 and the preferred source 5. In preferred embodiments, the network convergence component 3 is configured to select audiovisual information from the central source 1 for transmission to the television 4 during periods when programming (e.g., a sporting event or a situation comedy) is being presented by the central source 1, and select audiovisual information from the preferred source 5 for transmission to the television 4 when commercials are being presented by the central source 1. Accordingly, the network convergence component 3 continuously monitors the signal from the central source 1 to accomplish this function.

There are many techniques known to those of skill in the art for detecting commercials, and the network convergence component 3 uses some or all of these techniques in various embodiments. Among the techniques that can be used to detect commercials are:
1) detecting codes indicative of commercials in the data present in line 21 of an NTSC television transmission;
2) detecting “black” screens used by broadcasters when switching from programming to commercial; and
3) detecting various other codes present in the audio or video signals. Among the types of codes that may be detected (whether in line 21 or elsewhere) are closed caption start/end; network logo start/end; program rating start/end; and the signal used by network broadcasters to signal local affiliates to display local commercials/programming.

In some embodiments, the network convergence component 3 controls the preferred video source 5. For example, the network convergence component 3 may signal the preferred video source 5 to start transmitting audiovisual information so that the audiovisual information from the preferred source 5 is synchronized to the start of a commercial. In some embodiments, the network convergence component 3 also controls which particular audiovisual information is transmitted by the preferred source 5. For example, in some embodiments, the preferred source 5 stores a plurality of commercials and other data, and the network convergence component 3 selects from among the plurality of commercials for display on the television 4. This allows the network convergence component 3 to, for example, replay a commercial from the preferred source 5 that was “cut off” because the commercial break on the central source 1 ended before the entirety of the commercial from the preferred source 5 was transmitted.

In some embodiments, the preferred source 5 does little more than start and stop the supply of video upon receiving an appropriate command, or message, from the network convergence component 3. In other embodiments, the preferred source 5 includes additional functionality such as the ability to track and report the identity and transmission times of video that was supplied to the network convergence component 3 for display on the televisions 4. In these embodiments, the preferred source 5 may be implemented on a personal computer with audiovisual content stored on a hard disk, a DVD, or an external device such as a DVD player controlled by and connected to the personal computer. This reporting feature may be used in connection with the network operations center embodiments discussed below.

In other embodiments, the network convergence component 3 simply commands the preferred video source 5 to start and stop transmission in conformance with the start and stop of the commercial breaks from the central source. In such embodiments, the preferred source 5 may simply start and stop the transmission of the audiovisual information at the command of the network convergence component 3, or may intelligently transmit the audiovisual information to avoid “cut-offs” as described above.

In still other embodiments, the preferred video source 5 simply continuously transmits audiovisual information in a loop and the network convergence component switches between the preferred source 5 and the central source 1 as the central source 1 transitions to and from commercial breaks.

Any type of audiovisual information may be stored and transmitted from the preferred source 5. In some embodiments, promotional programming or “commercials” are stored. In other embodiments, video gaming presentations (which may constitute video gambling applications or arcade-style games played for fin) are stored. In still other embodiments, music videos are stored. In some embodiments, the audiovisual information relates to a theme. For example, in embodiments used in a bar, the stored audiovisual information may constitute promotional materials associated with a beer or alcohol company that has sponsored an event at the bar. In other embodiments, the audiovisual information may relate to the location, such as information about services and events in embodiments used in a hotel. The audiovisual information may also be only audio or only textual.

In some embodiments, the preferred source 5 may constitute a live feed from a source other than the central source 1. For example, in embodiments in which the central source is a cable television system, the preferred source 5 may constitute a satellite receiver or an internet connection through which a live event (e.g., horse racing) is received. In such embodiments, provisions may be made for gambling on the live event such as by provision of remote control devices which may communicate wagers through the preferred source 5.

It should be understood that the various televisions 4 in FIG. 1 may be tuned to the same or different channels. Accordingly, the preferred video source 5 preferably has the ability to output a plurality of video signals in response to independent commands from the various network convergence components 3. It should also be understood that various devices illustrated in FIG. 1 may be combined (e.g., the network convergence component 3 and the preferred video source 5).

In the embodiments described above, control over the network convergence component 3 and the preferred source 5 may be maintained locally; that is, within the same building. Such embodiments are particularly well suited for independently run establishments such as restaurants and bars. In other embodiments, one or both of the foregoing components is under the control of a centralized network operations center, or NOC. The NOC may communicate with the network convergence component and/or the preferred source via the Internet and/or any other network, including the PSTN.

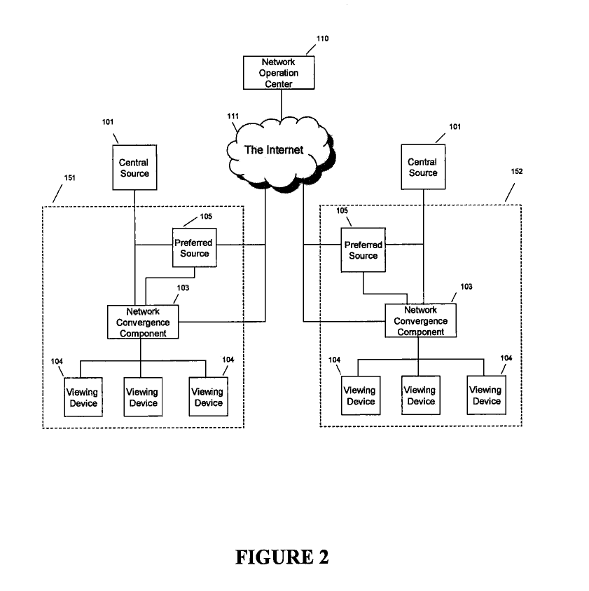

An exemplary embodiment including a NOC 110 is illustrated in FIG. 2. The NOC 110 is connected, via Internet 111, to control preferred sources 105 and/or network convergence components 103 for two systems 151, 152 (it should be understood that any number of systems 151, 152 may be controlled by the NOC 110). The NOC 110 pushes content to the preferred sources 105 in some embodiments and also receives information from the preferred sources 105 relating to dates and times at which various content was played by the preferred sources 105. The NOC 110 may also control the network convergence components 103 in some embodiments in a variety of ways, including enabling and disabling switching by the network convergence component 103 from the central source 101 to the preferred sources 105, controlling the selection of the preferred source 105 that is switched to by the network convergence component 103, etc. Although direct connections from the NOC 110 to the network convergence components 103 and preferred sources 105 are illustrated in FIG. 2, it should be understood that communications from the NOC 110 to either of the network convergence components 103 or the preferred source 105 may be conducted through the other device in various embodiments.

While the invention has been described with respect to certain specific embodiments, it will be appreciated that many modifications and changes may be made by those skilled in the art without departing from the spirit of the invention. It is intended therefore, that all such modifications and changes are within the true spirit and scope of the invention.

What is claimed is:

1. A system for controlling the supply of information to a viewing device, the system comprising:
a first information source;
a second information source;
a display device; and
a network convergence component connected to the central information source, the preferred information source, and the display device, the network convergence component configured to detect an event in the first information source and switch from the first information source to the second information source for output to the display device in response to the event.

2. The system of embodiment 1, wherein the event is the occurrence of an advertisement from the first information source.

3. The system of claim 2, wherein the occurrence of an advertisement is detected by detecting a code in a video signal of the central information source.

4. The system of claim 3, wherein the code is in line 21 of the video source.

5. The system of claim 1, wherein the display device is located in a building and the second information source is located in the same building.

6. The system of claim 5, wherein the second information source is a computer.

7. The system of claim 1, wherein the network convergence component and the second information source are in a single physical device.

8. The system of claim 1, wherein the second information source is a digital video disc player.

9. The system of claim 1, further comprising a network operations center connected to the network convergence component, wherein the network convergence component is under the control of the network operations center.

10. The system of claim 9, wherein the second information source is connected to the network operations center and receives information from network operations center.

11. A method for selecting output for display on a viewing device comprising the steps of:
monitoring a first information source;
detecting an event in the first information source;
switching from the first information source to a second information source for output to the viewing device upon detection of the event.

12. The method of claim 11, wherein the event is the occurrence of a commercial break by the central information source.

13. The method of claim 12, wherein the occurrence of the commercial break is detected by detecting a code in a video signal of the central information source.

14. The method of claim 12, further comprising the step of switching from the second source to the first source at a conclusion of the commercial break.

15. The method of claim 11, further comprising the step of synchronizing the second information source to start a display of information when the event is detected.

16. The method of claim 11, wherein the second information source is a computer.

17. The method of claim 11, wherein the second information source is a digital video disc player.

18. The method of claim 11, wherein the first information source is a cable television source.
